(19) United States
(12) Patent Application Publication
(10) Pub. No.: US 2011/0032119 A1
(43) Pub. Date: Feb. 10, 2011

(54) DRIVER ASSISTANCE PROGRAM

(75) Inventors: Jürgen Pfeiffer, Glashutten (DE); Mattias Strauss, Pfungstadt (DE); Enrico Rück, Taucha (DE); Ulrich Stählin, Eschborn (DE); Stefan Lüke, Sulzbach (DE); Matthias Komar, Wangen (DE)

Correspondence Address: RATNERPRESTIA, P.O. BOX 980, VALLEY FORGE, PA, 19482, US

(73) Assignee: CONTINENTAL TEVES AG & CO. OHG, Frankfurt (DE)

(21) Appl. No.: 12/864,747

(22) PCT Filed: Jan. 30, 2009
(86) PCT No.: PCT/EP09/51091

§ 371 Date: Oct. 8, 2010

(30) Foreign Application Priority Data
Jan. 31, 2008 (DE) 10 2008 007 144.7
Jan. 30, 2009 (DE) 10 2009 006 976.3

(51) Int. Cl. G08G 1/09

(52) U.S. Cl. 340/905

(57) ABSTRACT

A driver assistance system which outputs information to the driver on the traffic situation in the surroundings and provides assistance, by vehicle components, in order for the driver to handle a current traffic situation.

### CROSS REFERENCE TO RELATED APPLICATIONS

This application is the U.S. national phase application of PCT International Application No. PCT/EP2009/051091, filed Jan. 30, 2009, which claims priority to German Patent Application No. 10 2008 007 144.7, filed Jan. 31, 2008, and German Patent Application No. 10 2009 006 976.3, filed Jan. 30, 2009, the contents of such applications being incorporated by reference herein.

### FIELD OF THE INVENTION

The invention relates to a driver assistance system.

### BACKGROUND OF THE INVENTION

Driver assistance systems are known which assist a driver in certain situations. In principle, the driver assistance system reacts to the activities carried out by the driver. The main focus is on assistance intended to control the vehicle's own dynamics. Such driver assistance systems, however, involve the risk that the driver does not feel fully occupied or experiences the intervention of the driver assistance system as a loss of control over the vehicle.

### SUMMARY OF THE INVENTION

An object of the invention is to provide an alternative driver assistance system.

The aforesaid object is achieved by means of a driver assistance system which outputs information to the driver on the traffic situation in the surroundings and provides assistance, by vehicle components, in order for the driver to handle a current traffic situation, as well as a method for assisting a driver of a vehicle comprising the steps of detecting a traffic situation, and informing and assisting a driver of the vehicle by means of or via vehicle components in order for the driver to handle the traffic situation.

One exemplary embodiment is based on the generic state of the art, comprising a driver assistance system which outputs information on the surrounding traffic situation and provides assistance to the driver by means of vehicle components, in particular a steering system, a braking system, and a performance control system, in order for the driver to handle the current traffic situation.

Disclosed herein is a new, comprehensive concept for a driver assistance system called “Active Car”. It is intended to assist the driver in both his/her decision-making activities and his/her control actions. To implement such a system in the market, it is planned to make use of the fact that previous innovations in the automobile sector have been quicker to succeed if they were easy to utilize and to apply for each user and in each situation. It is thus a basic requirement that the system be easy to operate and behaves in a way that is logical to the driver. For example, the previous successful driver assistance system, ESP, intervenes in the driving behaviour of the vehicle in such a way that the driver's intention is continued to be realized to the extent permitted by the possibilities of physics. Current figures show that this kind of driver assistance is likely to be successful.

While the present driver assistance system is founded on this basis, it takes technology some decisive steps further. It is intended that the driver be informed on the current traffic situation at all times, in addition to being assisted when there is a risk of losing control over the vehicle. The main focus is not on assistance intended to control the vehicle's own dynamics, but on handling the traffic situation as a whole. One option would be the autonomous control of the vehicle in the longitudinal and transverse directions or an acoustic or visual warning to the driver. These approaches are not to be pursued since they involve the risk that the driver does not feel fully occupied or finds it difficult to associate the warning with the relevant situation.

According to another exemplary embodiment, the vehicle components can be operated by means of vehicle control elements, in particular a steering wheel, a brake pedal, and an accelerator pedal, and the information is output via said vehicle control elements. Instead of the steering wheel, brake pedal, and accelerator pedal, a joystick can be used which integrates the functions of the three aforesaid vehicle control elements, either in part or completely.

According to another exemplary embodiment, the information is output to the driver in haptic form. In this way, the driver can be reached quickly without diverting his/her attention from the traffic situation. In addition, the driver intuitively associates the warning with the relevant situation.

Moreover, one exemplary embodiment of the driver assistance system can modify the extent of the haptic warnings in accordance with the criticality of the traffic situation. In this way, the driver gets a good idea of the urgency to act.

Another exemplary embodiment focuses on that the driver assistance system changes the actuating force of the vehicle control elements, so that the perceived driving characteristics will change, thus providing a source of information to the driver. In this way, the driver is informed directly, via the vehicle control elements he/she has to operate anyway, which makes it easier for the driver to associate the information with the relevant situation.

Furthermore, it may be provided for the driver assistance system to maintain a control chain between the vehicle and the driver. In this way, the control chain which serves to control movement of the vehicle is never interrupted, thus making the driver feel that he/she is in control of the vehicle at all times.

In addition, it may be intended that the amount of assistance depends on a road type. In this way, the amount of assistance can depend on whether the car is on a city road, a highway, or a motorway, thus improving the quality of assistance since the urgency of action to be taken by the driver may depend on the road type.

Moreover, it may be intended that the amount of assistance depends on the accuracy of detection of the traffic situation. This feature also contributes to improving the quality of the information and of the assistance provided by the driver assistance system.

Furthermore, it may be intended that, in addition, a display be provided which informs the driver visually why he/she is being assisted. In this way, the driver is kept informed on the reason why assistance is needed, even if the reason is, for example, a speed limit and the relevant traffic sign has long been passed.

According to another exemplary embodiment, it may be intended that sensors be affixed to the vehicle in order to detect the traffic situation. These can include, for example, camera systems, radar sensors, and/or LiDAR sensors.

Furthermore, it may be intended that a satellite navigation receiver and/or a digital map, preferably a road map, be provided in order to detect the traffic situation.

In addition, it may be intended that the driver assistance system communicates with a traffic infrastructure and/or with other vehicles in order to detect the traffic situation. In this way, information can be transmitted to the driver assistance system which cannot be detected by the sensors described above, thus enabling even more precise information and assistance by the driver assistance system.

According to further exemplary embodiments, it may be intended that the assistance comprises an overlaid steering torque or steering angle and/or an overlaid force for actuation of the brake pedal.

Furthermore, it may be intended that the driving characteristics as they are subjectively perceived by the driver are detected and analysed. According to this exemplary embodiment, an attempt is made to foresee the behaviour of a driver and to assist him/her in handling a traffic situation.

Moreover, the present invention provides a vehicle comprising the aforesaid driver assistance system. This vehicle offers the advantages described above in an analogous manner.

### BRIEF DESCRIPTION OF THE DRAWINGS

The invention is best understood from the following detailed description when read in connection with the accompanying drawings. Included in the drawings is the following figures:

FIG. 1 shows a schematic functional diagram of the driver assistance system according to an exemplary embodiment of the invention;

FIG. 2 shows a diagram which illustrates the amount of information and assistance provided by the driver assistance system 12;

FIG. 3 is a diagram which illustrates the amount of information and assistance provided over time;

FIG. 4 illustrates the required range of sensors used to detect the traffic situation;

FIG. 5 shows an exemplary embodiment for a sensor concept; and

FIG. 6 shows another exemplary embodiment for a sensor concept.

### DETAILED DESCRIPTION OF THE PREFERRED EMBODIMENTS

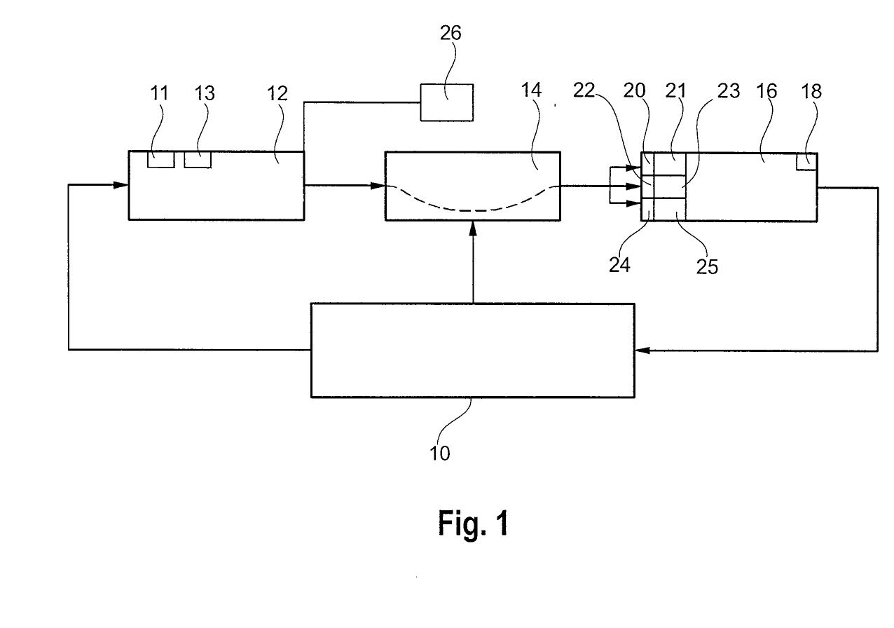

FIG. 1 shows a schematic functional diagram of the driver assistance system according to an exemplary embodiment of the invention. A current traffic situation 10 is detected by the driver assistance system 12 and perceived by the driver 14. The driver assistance system 12 comprises a CPU 11 and a memory unit 13 which is connected to the former and in which a plurality of potential traffic situations and parameters associating potential traffic situations with output of the driver assistance system 12 are stored. The driver assistance system 12 assists the driver 14 in handling the traffic situation 10, in accordance with said traffic situation 10, so that the driver 14 will control a vehicle 16 in an appropriate manner. Control of the vehicle 16 in turn influences the traffic situation 10 which is again detected by the driver assistance system 12 and by the driver 14. The vehicle 16 is controlled or operated by means of vehicle components, which are shown schematically, such as a steering system 21, a braking system 23, and a performance control system 25. The steering system 21 comprises a steering wheel 20, the braking system 23 comprises a brake pedal 22, and the performance control system 25 comprises an accelerator pedal 24. The interface between the aforesaid vehicle components and the driver 14 is established by the steering wheel 20, the brake pedal 22, and the accelerator pedal 24, which are collectively referred to as vehicle control elements. The vehicle control elements may further comprise a windscreen wiping system lever, a lighting switch, a direction indicator lever, etc. Instead of the steering wheel, brake pedal, and/or accelerator pedal, a joystick can be used. In this exemplary embodiment, however, only the conventional vehicle control elements are described. The invention covers implementation by means of a joystick though.

The driver 14 receives haptic information via the vehicle control elements 20, 22, 24 in all traffic situations 10, which indicates whether he/she and/or the other road users behave(s) properly according to the valid traffic rules, and incorrect behaviour is signalled to him/her in accordance with the situation. During this process, he/she is always in control of the vehicle 16, i.e. the driver is always part of the control chain. The functionality of the driver assistance system 12 does not comprise any autonomous intervention in the control of the vehicle 16.

It is intended that the driver assistance system 12 be designed to be functional at all times, regardless of whether the car is on a motorway, highway or city road. For this purpose, an electronic road map can be used which is coupled to a GPS receiver 18 in order to differentiate between road types in a targeted manner and adapt the parameters of the driver assistance system 12. On city roads, for example, it must be taken into account that less space is available for all manoeuvres. The system must therefore intervene in vehicle control later, but stronger. Exceptions are traffic situations 10 in which haptic information is output to the driver 14 via the steering wheel 20 and relevant objects are present on both sides of the vehicle 16. Here, the driver 14 can be informed continuously.

It must be ensured, however, that the driver assistance system 12 does not guide the driver 14 away from stationary vehicles towards pavements or cycle tracks.

The aforesaid driver assistance system 12 is intended to provide haptic information to the driver 14 at all times in accordance with the traffic situation 10 via the vehicle control elements 20, 22, 24, thus intervening in the vehicle behaviour in an indirect manner. In this way, the driver is always in control of the situation, i.e. part of the control chain which serves to control movement of the vehicle, but is better informed.

It is intended that assistance be provided in nearly all fields of action of the driver 14, specifically accelerating, braking, steering, indicating direction, and operating wipers and light.

To reach the driver 14 as quickly as possible, all interventions are realized on the basis of haptic information. In addition, it may be intended that the driver be informed visually as to which dangerous situation is imminent, if possible in a discreet manner. Any autonomous braking or steering interventions should be avoided. The system primarily serves to inform the driver.

The driver assistance system 12 is intended to detect, inform on and assist in the following traffic situations 10, among others:
1. Assistance in maintaining a safe following distance:
   If the driver follows another vehicle too closely, the accelerator pedal can be pressed against his/her foot in accordance with the situation. In critical situations, the vehicle can, in addition, be slightly decelerated in order to provide even more haptic feedback to the driver. The driver always has the option to override this intervention by pressing the accelerator pedal.
2. Assistance during braking:
   If the driver must brake due to a traffic situation, the brake pedal should move more easily. This is achieved by increasing the brake pressure to the value required to handle the relevant traffic situation without decoupling the brake pedal.
3. Assistance in approaching and passing crossings:
   If the driver approaches a crossing too fast, he/she can be warned of passing a red traffic light or not giving the right of way, as has been described in items 1 and 2 above.
4. Assistance in observing speed limits:
   In this case, it is intended that the driver be warned according to item 1 if he/she exceeds the maximum permissible speed. Here, it is advantageous that the driver also be informed visually on his/her mistake since the relevant sign is no longer visible when the driver assistance system intervenes.
5. Warning of entering a road opposite to the prescribed direction of driving (one-way street, motorway):
   Here, a no entry sign can be treated like a red traffic light. Due to the high criticality, the warning is stronger, so that the driver can still stop his/her vehicle before passing the relevant signs, according to items 1 and 2. In addition, entry is made difficult by pressing the accelerator pedal against the driver's foot.
6. Assistance in accelerating:
   If the driver changes to the adjacent lane at too low a speed, a restoring moment of the accelerator pedal can be reduced, so that the vehicle will accelerate faster although the force exerted by the foot is kept constant, i.e. the driver's intention is not disregarded. Also, the relation between the position of the accelerator pedal and acceleration of the vehicle is always the same, thus being plausible to the driver. Items 1 and 2 are of higher priority though.
7. Assistance in staying in the lane:
   To help the driver stay in the traffic lane, the driver assistance system can apply a slight counter-torque to the steering system when the vehicle approaches a lane marking.
8. Assistance in changing lanes:
   To warn the driver of a dangerous change of lanes, a stronger counter-torque can be applied to the steering system. The driver can continue to counteract slightly until lane change is possible, and will then feel that the counter-torque is reduced. If there is a risk of an offset collision with the vehicle driving in front assistance is not provided via the steering system, but always according to items 1 and 2.
9. Assistance during the approach of other vehicles to the driver's own one:
   In case the driver's own vehicle moves sideways, too close to stationary obstacles or other vehicles, an appropriate counter-torque is applied to the steering wheel. Said counter-torque may be very high, in accordance with the situation, although the driver must be able to override it.
10. Assistance in indicating direction:
   In case the driver forces a lane change although a counter-torque is applied to the steering wheel, the direction indicator can be activated automatically in this moment.
11. Assistance in adapting the speed to the surroundings:
   In case the speed is too high for the next curve, the driver's attention can be drawn to the traffic situation according to items 1 and 2. Again, additional visual information is required here since the driver is obviously not aware of the risk.
      As already mentioned above, the driver assistance system is coupled to three vehicle control elements 20, 22, 24 or actuators, which will be explained in detail below. These vehicle control elements 20, 22, 24 constitute the man-machine interface between the driver assistance system 12 and the driver 14 as well as between the vehicle 16 and the driver 14.

The accelerator pedal 24 is a Force Feedback Pedal which utilizes an actuator to apply a force, either in the same direction as or opposite to the actuating force exerted by the driver 14. In a dangerous situation, the accelerator pedal 24 is pressed against the driver's foot, or the restoring moment is reduced. It is to be considered, however, that the accelerator pedal 24 must always be designed such that autonomous acceleration is absolutely impossible.

The steering wheel 20 is coupled to an actuator which can overlay the steering torque or steering angle applied by the driver 14 with a supporting or counteracting torque or a supporting or counteracting steering angle. As an alternative, an electrical steering system can be provided to enable application of the relevant supporting torques or counter-torques to the steering wheel 20. The overlaid additional torque (or the overlaid additional angle) must be limited such that the driver 14 always has the option to override said additional torque (or said additional angle). For this purpose, the build-up speed must be limited appropriately, in addition to the absolute values.

The brake pedal 22 is provided with an actuator, or the braking system 23 is designed as an active braking system, so that braking pressure can be built up without external force being exerted by the driver 14. Since the aforesaid build-up of braking pressure cannot be overridden by the driver 14, it should be limited to 0.2 g; to inform the driver of the reason why he/she is assisted, the brake pedal 22 must not be decoupled, but must continue to be moved in accordance with the braking pressure build-up which has been specified (by the driver assistance system 12).

In addition, a visual man-machine interface is provided, which informs the driver 14 of the reason why he/she is assisted. For this purpose, a display 26 can conveniently be used, as is already installed in most large family and executive cars today. The visual indication should be as discreet as possible, except if the speed limit is exceeded (cases 4+11). Ideally, the information can only be seen by the driver 14 since otherwise the front-seat passenger might unnecessarily feel unsafe.

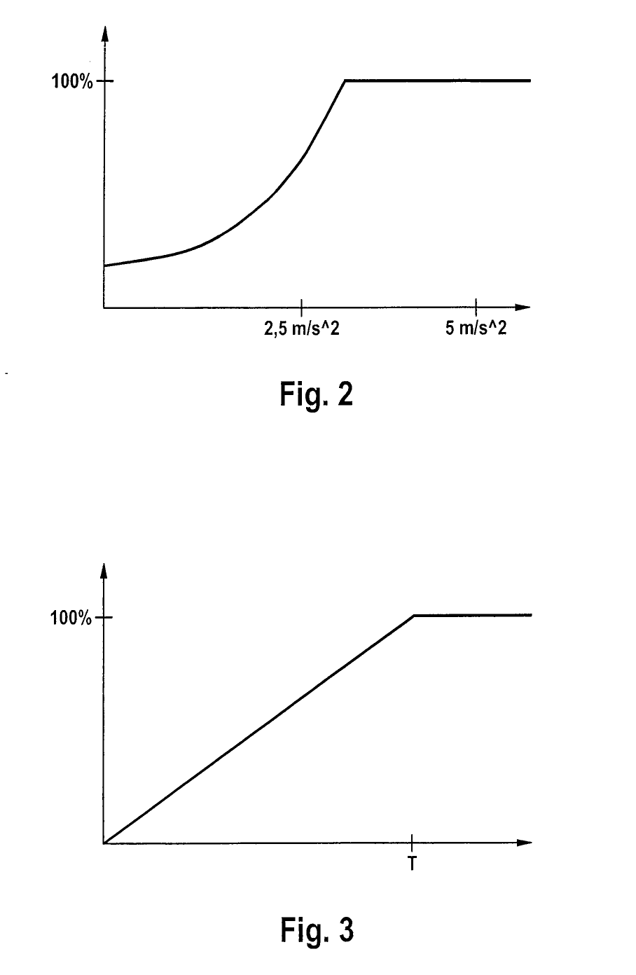

FIG. 2 shows a diagram which illustrates the amount of information and assistance provided by the driver assistance system 12. The extent of all haptic warnings is adapted to criticality. The criticality is given in [^{m}/s²] and equals the acceleration with which the driver would have to react to avoid an imminent accident. To ensure continued functionality in nearly all weather conditions, 5^{m}/s² are assumed as the permanently possible maximum. This value, however, must continue to be parameterizable, for development as well as later on. It could, for example, be adapted by the driver if he/she sets a comfort or sports mode in the running gear. In other words, the driver assistance system 12 must provide information and assistance early enough, so that the traffic situation 10 can be handled at an assumed maximum (positive or negative) acceleration of 5^{m}/s².

FIG. 3 is a diagram which illustrates the amount of information and assistance provided over time. The longer the period of time during which measurements relating to a relevant object or a traffic situation 10 are available the more reliable and exact are these measurements. To make use of this effect and to ensure at the same time that the haptic warnings do not include any abrupt changes of force or torque which might confuse the driver 14, said haptic warnings are intensified in a defined manner over time. In other words, this means that the intensity of the information and assistance provided by the driver assistance system increases over time until full information and assistance are available after a period of time T.

The duration of said increase depends mainly on an estimated reliability of the measurements made by sensors which are provided to detect the traffic situation. The force of the haptic warnings is kept limited such that the driver 14 always has the option to override them. In this way, the driver 14 is still able to control the vehicle 16 even in case of potential wrong interventions by the driver assistance system 12.

To be able to react in traffic situations 10 in which the measured data is not reliable, due to the number of measured data or to interference during the measurement, but where a situation analysis detects a dangerous situation, the counteracting force which is applied to the accelerator pedal 24 is to be reduced if a warning occurs in this type of traffic situations 10. In this way, the driver 14 still receives information on the traffic situation 10 by the sense of touch and can react immediately. In addition, the driver assistance system 12 and the driver 14 are prevented from reacting inappropriately to wrong measurements which would be interpreted as dangerous situations.

One of the main advantages of the reactive or active driver assistance system 12 is that the behaviour of said driver assistance system 12 can always be parameterized, specifically by means of the ramp function described above. In this way, an original equipment manufacturer can ensure that his vehicle 16 which is equipped with the driver assistance system 12 behaves in accordance with the corporate philosophy on the one hand. On the other, the driver 14 may be provided with suitable control elements to modify the behaviour of the driver assistance system 12 or switch it off.

Thanks to the very simple man-machine interface which is easy to understand for the driver 14, a large part of the information processing chain to be completed by the driver 14 is eliminated, thus greatly relieving him/her. In addition, the driver 14 can look in any direction to detect a potentially dangerous situation while, at the same time, another dangerous situation can be signalled to him/her. This is impossible with visual warnings and very difficult to achieve in case of acoustic warnings.

The driver assistance system can thus be parameterized using the characteristic intervention curves illustrated in FIGS. 2 and 3.

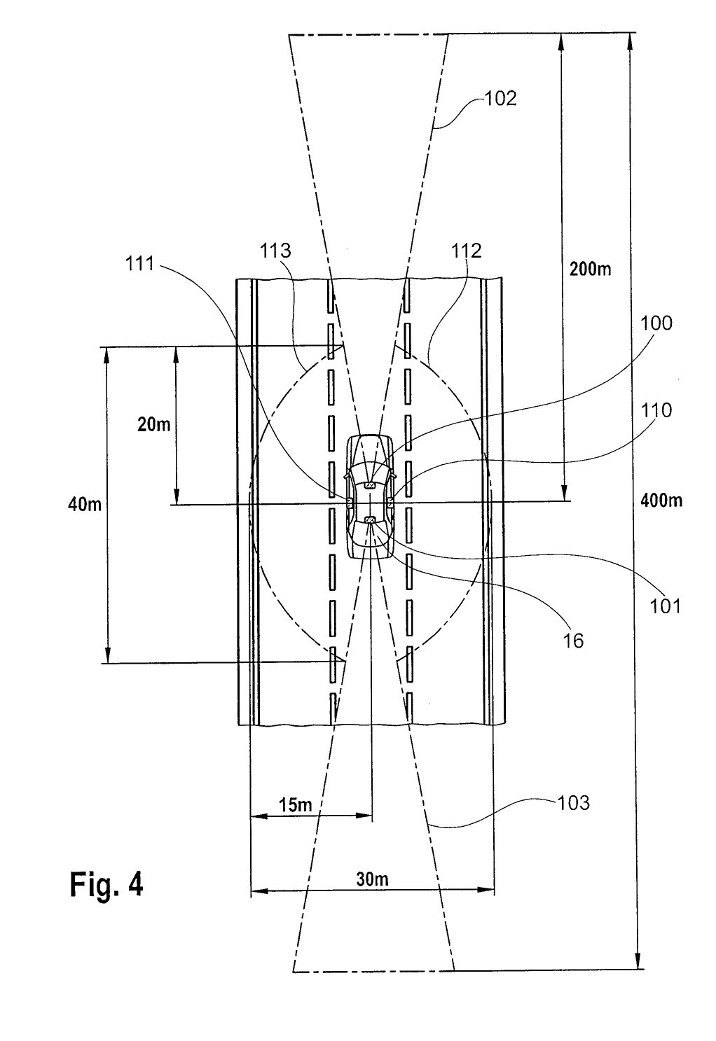

FIG. 4 illustrates the required range of sensors used to detect the traffic situation. Sensors are affixed to the vehicle in order to detect the traffic situation 10. For example, sensors 100, 101 (e.g. camera systems, LiDAR systems or radar systems) may be arranged behind the windscreen and the rear window or in the front and rear bumpers of the vehicle 16. These sensors 100, 101 scan the areas which are indicated by the reference numerals 102 and 103 in FIG. 4. Furthermore, sensors 110, 111 may be affixed to the sides of the vehicle 16 in order to scan the areas 112 and 113. As the performance of the sensors affixed to the vehicle 16 increases, the output of the driver assistance system 12 can also take into account smaller objects, pedestrians, or cyclists, in addition to other vehicles or larger objects.

To implement the relevant warnings in an effective manner, comprehensive information relating to the surroundings must be available. Since the relative speeds in the longitudinal direction are mostly high, the sensors must have very great ranges. As a guiding value, 200-300 m should be sufficient for a function which can be properly represented, as illustrated in FIG. 4. In the lateral area, however, 10-15 m are sufficient since the speeds achieved in the transverse direction are usually not high in road traffic. In crossing situations where other vehicles approach from the side, the number of useful potential interventions by the driver assistance system 12 described herein is low anyway. For interventions in the transverse direction on motorways, however, objects in adjacent lanes must also be observed. For this purpose, an area of 15-20 m would have to be scanned. To enable the driver assistance system 12 to warn of dangerous curves, suitable map material and a functionally coupled satellite navigation system or positioning system (e.g. GPS or Galileo) must be available. The minimum sensor requirements are therefore 200 m in the longitudinal direction of the vehicle and 15 m in the transverse direction of the vehicle.

An additional approach would be the use of C2I (car-to-infrastructure) communication to transmit local features of curves. These would also include friction coefficient conditions. C2C (car-to-car) communication, on the other hand, can be used to expand the ranges of the sensors or even to replace the latter. The minimum requirements made of this sensor concept would also be the ranges illustrated in FIG. 4 (not true to scale).

All warnings and interventions should only take place in the comfort range. Suitable emergency braking and emergency steering functions continue to be available as separate functions and are intended to be activated only in real emergencies. This limited functionality and the corresponding limitation of the accelerations which occur to the comfort range also ensure operability of the systems in nearly all weather conditions.

Two basic requirements are to be met when implementing the system. On the one hand, oncoming objects and objects which approach from behind should be validated by a second sensor system whose features are orthogonal to those of the first one. In this way, the driver could, in addition, be warned more strongly and assisted better in braking in imminent rear-end collision situations at high relative speeds. Beam sensors are sufficient in the sideways directions since there are no high relative speeds here, except in crossing situations, i.e. when crossing the path of other vehicles. In such situations, however, the driver 14 cannot be assisted by the driver assistance system 12 to a sufficient degree since the opportunities for emergency manoeuvres are very limited.

Furthermore, a hands-off detection is required in order to warn the driver 14 of passing control to the vehicle 16 since the driver 14 is always required to react adaptively in extremely dynamic dangerous situations.

For this reason, the vehicle 16 must also slow down as soon as the driver 14 lets go the steering wheel 20.

In the forward direction, it is advantageous to use a camera system in order to detect signs (right of way, speed) and traffic lights.

The use of LiDAR sensors would have the advantage that, in particular at roadwork sites, objects could also be detected which are not conductive, as is required in case of radar. In this way, it can also be ensured that site entrances marked by roadwork site markers are signalled to the driver in haptic form.

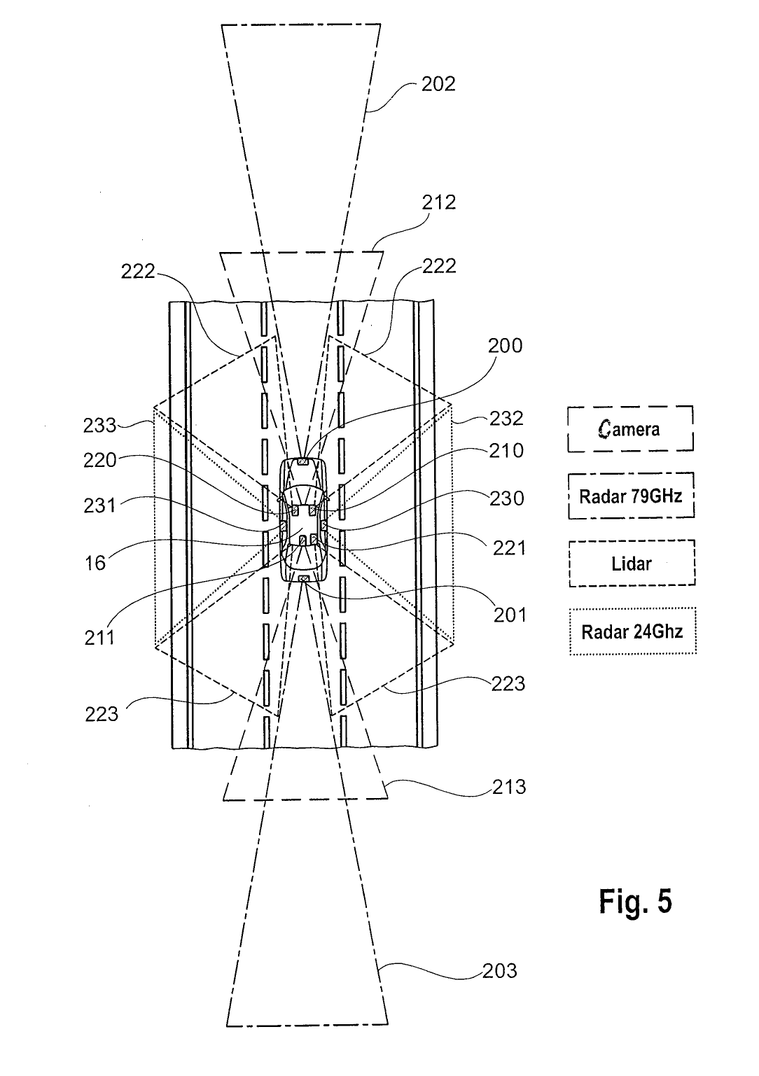

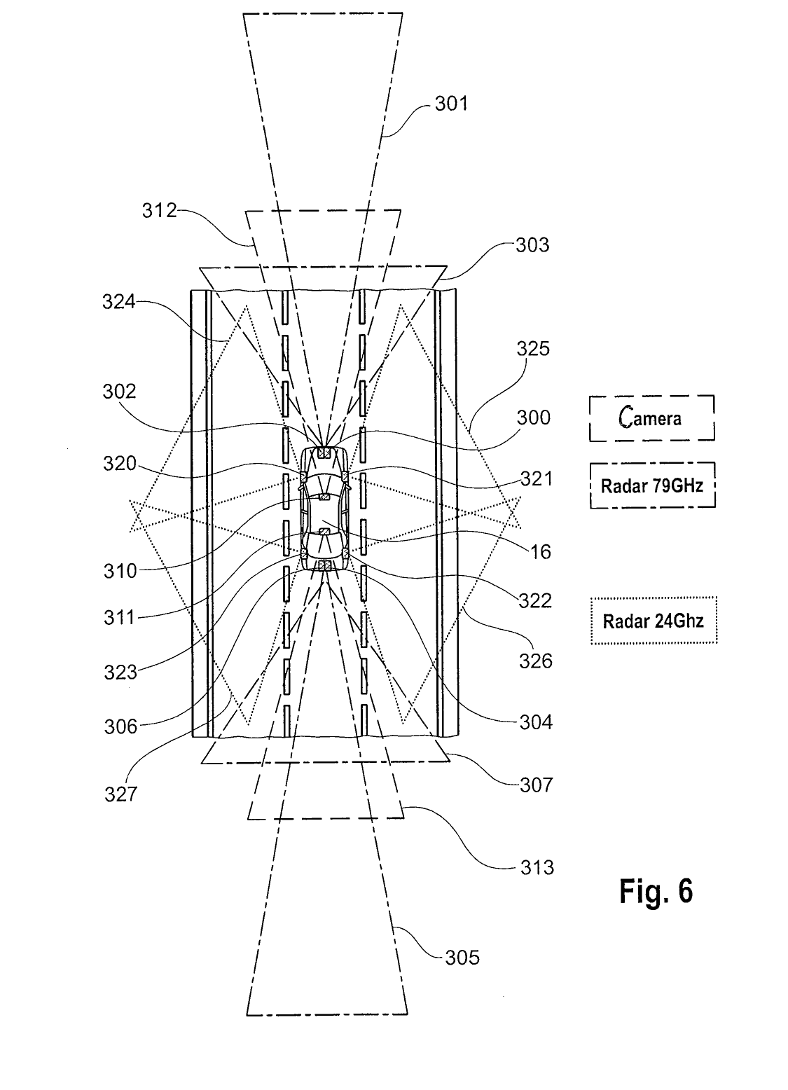

The following configurations are intended as examples for integration in a vehicle, though they are not necessarily the only ones. Based on the requirement that sensors should be selected which do not involve excessive costs, the following sensor concepts, which are shown in FIGS. 5 and 6, would be suitable.

FIG. 5 shows an exemplary embodiment for a sensor concept. In this concept, 79 GHz radar sensors 200, 201 for the far range are integrated in the front and rear bumpers of the vehicle 16. Said sensors cover the areas which are indicated by the reference numerals 202 and 203. Furthermore, camera systems 210, 211 are arranged behind the windscreen and the rear window of the vehicle 16. The camera systems scan the areas which are indicated by the reference numerals 212 and 213 in FIG. 5. In addition, LiDAR sensors 220, 221 which are assigned to the scanning areas 222 and 223 are arranged behind the windscreen and the rear window of the vehicle 16. The camera systems 210, 211 and the LiDAR sensors 220, 221 should be integrated such that both systems are arranged in the wiped or protected area of the vehicle windows. Radar systems 230, 231 which serve to monitor the areas to the side of the vehicle 16 are integrated in the body sills of the vehicle 16, below the C columns. Said radar systems 230, 231 cover the areas 232 and 233.

FIG. 6 shows another exemplary embodiment for a sensor concept. In this concept, a radar sensor 300 which covers a far range indicated by 301 is integrated in the front bumper of the vehicle 16. Furthermore, a radar sensor 302 covering a near range 303 is integrated in the front bumper. A radar sensor 304 for the far range 305 and a radar sensor 306 for the near range 307 are integrated in the rear bumper of the vehicle 16. All the aforesaid radar sensors operate at a frequency of 79 GHz. Furthermore, camera systems 310, 311 are arranged behind the windscreen and the rear window of the vehicle 16. The camera systems 310, 311 scan the areas which are indicated by the reference numerals 312 and 313 in FIG. 6. The camera systems 310, 311 should be installed such that said systems are arranged in the wiped or protected area of the vehicle windows. Radar systems 320, 321, 322, 323 which serve to monitor the areas to the side of the vehicle 16 are integrated in the front and rear wings of the vehicle 16. These radar systems 320-323 cover the areas 324, 325, 326 and 327.

As additional functions, an ACC or a steering stability feature as well as a parking assistant may be realized in one exemplary embodiment. These functions must then be switched on separately by the driver 14 and must return the regulatory function to the driver 14 as soon as the system limits are reached. The design of this return involves additional risk factors and is not intended to be part of the driver assistance system 12. Such additional functions can, however, improve the cost functionality ratio.

According to an exemplary embodiment, it is intended that information relating to the surrounding traffic situation be provided to the driver 14 by assisting him/her in maintaining a safe following distance, wherein the accelerator pedal 24 is pressed against his/her foot in accordance with the situation if the driver follows another vehicle too closely, and the vehicle 16 is decelerated autonomously in critical traffic situations in order to give even more haptic feedback to the driver 14.

According to another exemplary embodiment, it is intended that a brake pedal 22 will move more easily in order to assist in braking by increasing the brake pressure to the required value without decoupling the brake pedal 22.

According to another exemplary embodiment, it is intended that the driver 14 be assisted if he/she approaches or passes crossings too fast.

According to another exemplary embodiment, it is intended that the driver 14 be assisted in observing speed limits and that, in addition, the driver 14 be informed visually on the current speed which exceeds the maximum permissible speed.

According to another exemplary embodiment, it is intended that the driver be warned of entering a road opposite to the prescribed direction of driving.

In addition, it should be pointed out that features which have been described with reference to one of the aforesaid further developments can also be used in combination with other features of other further developments described above.

1.-17. (canceled)

18. A driver assistance system wherein information on the surrounding traffic situation is output and assistance is provided, by way of vehicle components, to a driver in order for the driver to handle a current traffic situation.

19. A driver assistance system according to claim 18, wherein the vehicle components can be operated by vehicle control elements, and the information is output via said vehicle control elements.

20. A driver assistance system according to claim 18, wherein the information is output to the driver in haptic form.

21. A driver assistance system according to claim 20, wherein the haptic information depends on criticality of the traffic situation.

22. A driver assistance system according to claim 19, wherein the driver assistance system changes an actuating force of the vehicle control elements, so that perceived driving characteristics will change, thus providing a source of information to the driver.

23. A driver assistance system according to claim 18, wherein said driver assistance system maintains a control chain between the vehicle and the driver.

24. A driver assistance system according to claim 18, wherein an amount of assistance depends on a road type.

25. A driver assistance system according to claim 18, wherein an amount of assistance depends on the accuracy of detection of the traffic situation.

26. A driver assistance system according to claim 18, wherein, in addition, a display is provided which informs the driver visually why the driver is being assisted.

27. A driver assistance system according to claim 18, wherein sensors are affixed to the vehicle in order to detect the traffic situation.

28. A driver assistance system according to claim 18 wherein a satellite navigation receiver and/or a digital map is/are provided in order to detect the traffic situation.

29. A driver assistance system according to claim 18, wherein the driver assistance system communicates with a traffic infrastructure and/or with other vehicles in order to detect the traffic situation.

30. A driver assistance system according to claim 18, wherein the assistance comprises an overlaid steering torque or steering angle.

31. A driver assistance system according to claim 18, wherein the assistance comprises an overlaid force to actuate a brake pedal of the vehicle.

32. A driver assistance system according to claim 18, wherein the driving characteristics as they are subjectively perceived by the driver are detected and analysed.

33. A vehicle comprising a driver assistance system according to claim 18.

34. A method for assisting a driver of a vehicle comprising the steps of:
detecting a traffic situation, and
informing and assisting a driver of the vehicle by means of or via vehicle components in order for the driver to handle the traffic situation.
